(19) United States
(12) Patent Application Publication
(10) Pub. No.: US 2009/0319287 A1
(43) Pub. Date: Dec. 24, 2009

(54) AUTHENTICATION SEGMENTATION

(76) Inventors: Ayman Hammad, Pleasanton, CA (US); Khalid El-Awady, Mountain View, CA (US); Thomas Hardy Jackson, III, San Francisco, CA (US); Brian Triplett, San Ramon, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/145,346

(22) Filed: Jun. 24, 2008

(51) Int. Cl. G06Q 40/00

(52) U.S. Cl. 705/1

(57) ABSTRACT

Methods and systems of authentication segmentation to selectively apply authentication tools to target high risk segments of transactions and entities. The methods and systems identify a plurality of fraud reduction tools and determine segmentation metrics associated with the plurality of fraud reduction tools. One or more segments are determined based on the segmentation metrics using fraud data and the best candidates of the one or more segments is identified. One or more fraud reduction tools is selected that target the best candidates.

### BACKGROUND

The demands of our modern economy have spurred a great increase in the number and complexity of methods and devices for engaging in financial transactions. The greater sophistication has not made us immune to old problems such as fraud. Fraudulent activity can be very costly to merchants, financial institutions such as issuers, consumers, and others.

A number of authentication tools have been developed that ensure payment transactions are conducted securely. Some authentication tools authenticate consumers to help ensure that only authorized consumers are conducting transactions. Other authentication tools authenticate portable consumer devices used by consumers.

Fraud typically is targeted at specific types of transactions and entities. While some existing authentication tools may be effective in combating fraud, uniformly implementing authentication tools across all transactions and entities is costly and can needlessly disrupt legitimate transactions and inconvenience customers.

Embodiments in this disclosure address these and other problems individually and collectively.

### SUMMARY

Embodiments of the disclosure address the above-noted problems by providing a methods and systems of authentication segmentation. Authentication segmentation generally refers to the selective application of authentication tools to target high risk segments of transactions and entities.

One embodiment of the disclosure is directed to a method that identifies a plurality of fraud reduction tools and determines segmentation metrics associated with the plurality of fraud reduction tools. The method also determines one or more segments based on the segmentation metrics using fraud data and identifies the best candidates of the one or more segments. Also, the method selects one or more fraud reduction tools of the plurality of available fraud reduction tools. The selected one or more fraud reduction tools target the best candidates.

Another embodiment of the disclosure is directed to a system having one or more databases for storing fraud data and a server coupled to the one or more databases. The server is configured to identify a plurality of fraud reduction tools and determine segmentation metrics associated with the plurality of fraud reduction tools. The server also retrieves fraud data from the one or more databases and determines one or more segments based on the segmentation metrics using the fraud data. In addition, the server identifies the best candidates of the one or more segments and selects one or more fraud reduction tools of the plurality of available fraud reduction tools. The one or more fraud reduction tools target the best candidates.

Other embodiments of the disclosure are directed to specific combinations of other aspects of authentication segmentation. Further details regarding embodiments of the disclosure are provided below in the Detailed Description.

### BRIEF DESCRIPTION OF THE DRAWINGS

FIG. 1 is a block diagram illustrating an exemplary authentication segmentation system, in accordance with an embodiment of the disclosure.

FIG. 2 shows a block diagram of aspects of authentication tools available to authentication segmentation system, in accordance with an embodiment of the disclosure.

FIG. 2 shows an illustration of components of a magnetic stripe card, in accordance with an embodiment of the disclosure.

FIG. 4 is a flowchart illustrating a method of segmented authentication, in accordance with an embodiment of the disclosure.

FIG. 5 is a table schematically illustrating segmentation for dynamic challenge response (DCR) authentication, in accordance with an embodiment of the disclosure.

FIG. 6 is a table of results from segmentation of transactions based on DCR authentication, in accordance with an embodiment of the disclosure.

FIG. 7 is a table of results from segmentation of merchants based on DCR authentication, in accordance with an embodiment of the disclosure.

FIG. 8 is a table of results from segmentation of merchants based on DCR authentication, in accordance with an embodiment of the disclosure.

FIG. 9 is a block diagram of components in a computer apparatus, in accordance with an embodiment of the disclosure.

### DETAILED DESCRIPTION

Embodiments of the disclosure are directed to methods and systems for providing authentication segmentation. These methods and systems use fraud data to identify segments of transactions and/or entities that would benefit most from available authentication tools. This fraud data is used to develop a multi-layer authentication strategy that optimally deploys select authentication tools targeting high-risk segments.

In some embodiments, fraud data is collected about transactions and entities. The transactions and entities are grouped together into segments based on shared risk characteristics. The segments are evaluated based on the segmentation metrics. The segments that would most benefit from the available fraud reduction tools are selected as the best candidates. A multi-layer authentication strategy is developed with an optimal set of authentication tools that target the best candidates to maximize return on investment and minimize the number of customers effected.

Certain embodiments of the disclosure may provide one or more technical advantages. One technical advantage to issuers and other entities may be a more cost effective utilization of authentication tools which could improve return on investment for developing and implementing fraud reduction tools. One technical advantage to consumers may be that only effective authentication tools that target high-risk segments are implemented. Implementing only effective fraud reduction tools could minimize restrictions on legitimate activities and may avoid inconveniencing consumers. Another technical advantage to consumers may be that since fraud reduction tools are more cost-effectively implemented, more fraud reduction tools may be available to consumers. If more fraud reduction tools are made available, protection from fraudulent activities may improve.

Certain embodiments of the disclosure may include none, some, or all of the above technical advantages. One or more other technical advantages may be readily apparent to one skilled in the art from the figures, descriptions, and claims included herein.

I. Authentication Segmentation System

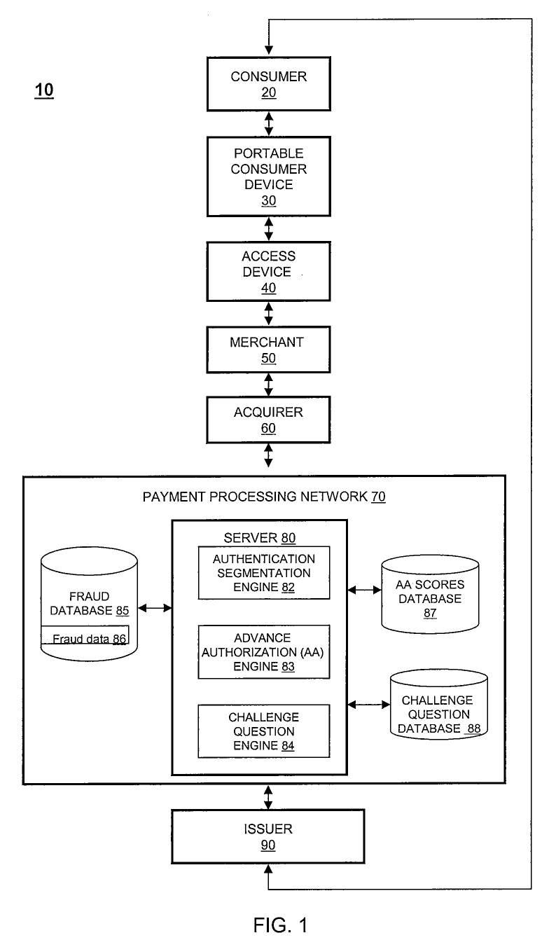

FIG. 1 is a block diagram illustrating an exemplary authentication segmentation system 10, in accordance with an embodiment of the disclosure. Authentication segmentation system 10 includes a consumer 20, a portable consumer device 30 associated with consumer 20, an access device 40, a merchant 50, an acquirer 60 associated with merchant 50, a payment processing network 70, and an issuer 90. Payment processing network 70 includes a server 80 having an authentication segmentation engine 82 for providing certain authentication segmentation functions, an advanced authorization (AA) engine 8 for determining AA scores, and a challenge question engine 84 for determining challenge questions. Payment processing network 70 also includes a fraud database 85 for storing fraud data 86, an AA scores database 87, and a challenge question database 88. Although one consumer 20, one portable consumer device 30, one access device 40, one merchant 50, one acquirer 60, and one issuer 90 are shown, there may be any suitable number of any of these entities in authentication segmentation system 10.

In authentication segmentation system 10, consumer 20 is in operative communication with portable consumer device 30 for making a transaction such as a purchase of goods or services. Consumer 20 is also in communication with issuer 90. Access device 40 is in operable communication with portable consumer device 30 and with merchant 50. Acquirer 60 is in communication with issuer 70 through payment processing network 70. Payment processing network 70 is in operative communication with acquirer 60 and issuer 90. In other embodiments, payment processing network 70 may also be in operative communication with other entities such as other consumers, other issuers, marketing analysts, and organizations such as credit bureaus, credit agencies for collecting fraud data 86 and other data that may be useful in providing authentication segmentation.

Although authentication segmentation engine 82, AA engine 82, and challenge question engine 84 are shown as being part of the payment processing network 70, they may be outside payment processing network 70 in other embodiments. Authentication segmentation engine 82, AA engine 82, and/or challenge question engine 84 may be embodied by software code that resides on one or more computers within payment processing network 70. Any of the functions performed by Authentication segmentation engine 82, AA engine 82, and/or challenge question engine 84 may be embodied by computer code, and/or instructions which may be executed by one or more processors.

Consumer 20 refers to an individual or organization such as a business that is capable of purchasing goods or services or making any suitable transaction with merchant 50.

Portable consumer device 30 refers to any suitable device that allows the transaction to be conducted with merchant 40. Portable consumer device 30 may be in any suitable form for generating and storing data related to the transaction. Suitable portable consumer devices 30 can be hand-held and compact so that they can fit into a consumer's wallet and/or pocket (e.g., pocket-sized). Examples of portable consumer devices 30 may include smart cards, magnetic stripe cards, keychain devices (such as the Speedpass™ commercially available from Exxon-Mobil Corp.), etc. Other examples of portable consumer devices 30 include cellular phones, personal digital assistants (PDAs), pagers, payment cards, security cards, access cards, smart media, transponders, and the like. Portable consumer device 30 may be associated with an account of consumer 20 such as a bank account.

Portable consumer device 30 may include any suitable components for generating and storing data related to the transaction. Portable consumer device 30 may also include processors (e.g., microprocessors), antennas, batteries, other memory, displays, integrated circuit cards, and other suitable components. Portable consumer devices 30 may also include interface regions for allowing portable consumer device 30 to communicate data to access device 40. Interface regions may include, for example, antennas or electrically conductive elements.

An exemplary portable consumer device 30 comprises a computer readable medium (CRM) and a body. The computer readable medium may be on the body or may be detachable from it. The body may be in the form of a plastic substrate, housing, or other structure. The computer readable medium may be a memory that stores data and may be in any suitable form. Some examples of computer readable media include a magnetic stripe, a memory chip, etc. If computer readable medium is on a card, it may have an embossed region (ER) which is embossed data such as a primary account number (PAN). The computer readable medium may electronically store the PAN as well as other data such as PIN data.

The computer readable medium may store card data. The card data may be in any suitable form. For example, card data may be in the form of Track data as understood by one of ordinary skill in the credit card industry, such as the primary account number, expiration data, service codes, and discretionary data. Some card data may be encrypted. Card data may comprise any suitable combination of dynamic and static data elements. Dynamic data elements refer to data that can change over time. Static data elements refer to data that does not usually change over time. In some cases, dynamic data elements can be used to help ensure that portable consumer device 30 is authentic. Dynamic data elements may include any suitable data that changes over time. For example, dynamic data elements may represent the time of day, the current transaction amount, the terminal ID, the merchant ID, a randomly generated number, etc. An exemplary embodiment of a dynamic data element is a counter.

In some cases, portable consumer device 30 may include a contactless transmitter for sending wireless signals, a processor for processing the functions of portable consumer device 30, and a computer readable medium (CRM) in communication with each other. Contactless transmitter refers to any suitable device for sending wireless signals with information stored in memory (e.g. CRM) on portable consumer device 30 to another suitable device. The contactless transmitter transmits signals using a near field communications (NFC) capability to send information from portable consumer device 30 to the contactless receiver on the other device. Typically, NFC capability is in accordance with a standardized protocol or data transfer mechanism (e.g., ISO 14443/NFC). Some examples of NFC capability are radio-frequency identification (RFID), Bluetooth™, infra-red, and other suitable communications capability. In other embodiments, the contactless transmitter transmits information via a cellular network by means of an interface. The interface functions to permit exchange of data between the cellular network and the contactless transmitter.

Merchant 50 refers to any suitable entity or entities that makes a transaction with consumer 20. Merchant 50 may use any suitable method to make the transaction. For example, merchant 50 may use an e-commerce business to allow the transaction to be conducted by merchant 50 through the Internet. Other examples of merchant 50 include a department store, a gas station, a drug store, a grocery store, or other suitable business.

Access device 40 may be any suitable device for communicating with merchant 40 and for interacting with portable consumer device 30. Access device 40 can be in any suitable location such as at the same location as merchant 50. Access device 40 may be in any suitable form. Some examples of access devices 40 include POS devices, cellular phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, websites, and the like. Access device 40 may use any suitable contact or contactless mode of operation to send or receive data from portable consumer devices 30.

If access device 40 is a point of sale (POS) terminal, any suitable POS terminal may be used including card readers. The card readers may include any suitable contact or contactless mode of operation. For example, an exemplary card reader can include radio frequency (RF) antennas, optical scanners, bar code reader, magnetic stripe readers, etc. to interact with portable consumer device 30.

Acquirer 60 refers to any suitable entity that has an account with merchant 50. In some embodiments, acquirer 60 may also be an issuer 90.

Issuer 70 refers to any suitable entity that may open and maintain an account associated with portable consumer device 30 for an account holder such as consumer 20. Some examples of issuers may be a bank, a business entity such as a retail store, or a governmental entity. In many cases, issuer 70 also issues portable consumer device 30 associated with the account to consumer 20.

Payment processing system 70 may include data processing subsystems, networks, and operations used to support and deliver authentication services, authorization services, clearing and settlement services, and other related services. An exemplary payment processing system may include VisaNet™. Payment processing systems such as VisaNet™ are able to process credit card transactions, debit card transactions, and other types of commercial transactions. VisaNet™, in particular, includes a VIP system (Visa Integrated Payments system) which processes authorization requests and a Base 11 system which performs clearing and settlement services.

Payment processing network 70 includes server 80. A “server” or server computer” is typically a powerful computer or cluster of computers. For example, server 80 can be a large mainframe, a minicomputer cluster, or a group of servers functioning as a unit. In one example, server 80 may be a database server coupled to a Web server. Payment processing network 70 may use any suitable wired or wireless network, including the Internet.

Authentication segmentation engine 82, AA engine 82, and challenge question engine 84 retrieve information from any suitable combination of databases available to payment processing network 70 and retrieve information from any suitable combination of available databases. In the illustrated embodiment, payment processing network 70 includes fraud database 85, AA scores database 87, and challenge question database 88. Fraud database 85, AA scores database 87, and challenge question database 88 may include any hardware, software, firmware, or combination of the preceding for storing and facilitating retrieval of information. Also, fraud database 85, AA scores database 87, and challenge question database 88 may use any of a variety of data structures, arrangements, and compilations to store and facilitate retrieval of information.

In the illustrated embodiment, authentication engine 82 retrieves fraud data 86 from fraud database 85 and stores fraud data 86 to fraud database 85. Fraud data refers to any suitable information related to transactions conducted over payment processing network 70 and entities associated with payment processing network 70 that can be used to perform authentication segmentation functions. Fraud data may include, for example, average transaction values such as the average transaction value conducted at a merchant 50, the average transaction by a consumer 20, and the average transaction value conducted using a portable consumer devices 30 issued by issuer 90. Other examples of fraud data include total dollar amount of fraudulent transactions conducted at a merchant 50, the cost of fraud to a consumer 20, a merchant 50, an acquirer 60, or an issuer 90, the amount of fraud per lane at a merchant 50, the type of environment at a merchant 50 such as a multi-lane terminal environment, the type of industry that merchant 50 belongs to, time spent by consumer 20 to decide on making a transaction, the number of repeat customers vs. new customers conducting transactions at merchant 50, the type(s) of transaction that are conducted by merchant 50. Some examples of types of transactions include E Commerce and mail order/telephone order (MOTO) transactions. Fraud data may include historical and/or current data. Fraud data may be derived from any suitable financial transaction data such as authorization and settlement information related to the purchase of goods or services, public record data, consumer payment data, check clearing data, and the like.

An example of fraud data is an AA score. An AA score refers to a measure of the current risk level of a transaction and can be a measure of a likelihood that the transaction is fraudulent. A transaction refers to an event pertaining to an account and/or an account holder such as consumer 20 that impacts the risk level of that account and/or account holder to fraud. Examples of transactions include, for example, authorization requests for purchase of foods or services made on credit, clearing, and settlement transactions between merchants 50 and issuers 90, issuer-supplied account records, public records, and the like. Since AA scores are based on transactions which reflect current events, AA scores more accurately reflect the current fraud risk level of a particular account and/or account holder. AA scores typically range from 1(low risk) −99(high risk). In the illustrated embodiment, AA engine 83 retrieves AA scores from AA scores database 87 and stores AA scores to M scores database 87.

In the illustrated embodiment, challenge question engine 84 retrieves challenge questions and answers from challenge question database 88. Any suitable entity such as issuer 90 may store the challenge questions and answers in challenge question database 88. A challenge question refers to a query used to authenticate consumer 20 by one or more authentication tools. Some challenge questions are questions sent to consumer 20 that require a correct answer to authenticate consumer 20. The challenge questions may be static where the same questions are asked for each purchase transaction or dynamic where different questions may be asked over time. The questions asked may also have static or dynamic (semi-dynamic or fully dynamic) answers. For example, the question “What is your birthday?” requires a static answer, since the answer does not change. The question “What is your zip-code?” requires a semi-dynamic answer, since it could change or can change infrequently. Lastly, the question “What did you purchase yesterday at 4 pm?” would require a dynamic answer since the answer changes frequently. In other cases, challenge questions are not questions that are specifically answered by consumer 20 such as messages that query the location of portable consumer device 30 or a code associated with portable consumer device 30.

Authentication segmentation engine 82 performs various authentication segmentation functions. For example, authentication segmentation engine 82 determines the authentication tools available for use by authentication segmentation system 10. In some cases, the authentication tools may be made available by parties associated with authentication segmentation system 10 such as merchants 50, acquirers 60, or issuers 90. In other cases, parties outside authentication segmentation system 10 may provide the authentication tools.

Authentication segmentation engine 82 also determines segmentation metrics associated with the available authentication tools. A segmentation metric refers to any suitable attribute of a transaction or entity that indicates that implementing an authentication tool may effectively and efficiently reduce fraud associated with the transaction or entity. An entity refers to any individual or suitable combination of portable consumer devices 30, consumers 20, access devices 40, merchants 50, acquirers 60, issuers 90, or other suitable parties involved in transactions conducted using payment processing network 70. Segmentation metrics indicate, for example, that implementing a particular authentication tool may maximize the number of merchants effected by the tool, may maximize the return on investment (ROI), may minimize cost of deployment, and/or may minimize cardholder inconvenience. Also, a segmentation metric may indicate that the authentication tool can be implemented within time-lines required by issuers, merchants, consumers, or acquirers.

Some segmentation metrics of merchants 50 indicate that implementing a particular authentication tool at merchants 50 may maximize the return on investment. For example, having high total fraud amounts and/or high fraud per lane may show a higher probability of having a good financial return when implemented authentication tools which indicates a good return on investment. Low total fraud amounts and/or fraud per lane can indicate a low financial return and low return on investment. High referral rates, high manual orders, and high rentals are segmentation metrics describing merchants 50 and that may also indicate a good financial return and thus high return on investment. Low referral rates, low manual orders, and low rentals may indicate a low financial return and low return on investment. Other segmentation metrics describing merchants 50 include the type of consolidated industry that merchants 50 belong to. If authentication tools are applied merchants 50 in consolidated industries, there is a lower chance that fraud may migrate to another merchant 50 in the same industry which would indicate a higher return on investment. Other segmentation metrics describing merchants 50 can indicate that implementing authentication tools to merchants 50 sharing those segmentation metrics fits within consumer's experience. Examples of segmentation metrics associated with fitting within consumer's experience include whether merchants 50 conduct eCommerce transactions, whether merchants conduct transactions for high ticket sales items, whether products sold by merchants 50 typically require long sales time, and whether merchants 50 have a multi-lane terminal environment. If merchant 50 conducts transactions using eCommerce, consumers may not mind a few authenticating inputs on a website so that implementing authentication tools fits within consumer's experience. If the merchant 50 conducts transactions having high ticket size and/or merchants 50 products typically require a long sales time, implementing authentication tools at merchant 50 may fit within the consumer's experience.

Some segmentation metrics of transactions indicate whether implementing particular authentication tools to those transactions may fit within consumer's experience. For example, segmentation metrics may indicate whether the transaction is conducted by a repeat or new consumer. If the transaction is conducted by a repeat consumer, implementing authentication tools that may delay and complicate the transaction may annoy the consumer and not fit within consumer's experience. If the transaction is associated with a new consumer, the new consumer may expect authentication tools to be used and thus may fit within the new consumer's experience. Another example of segmentation metrics describing transactions includes whether a transaction is a higher than average ticket size. If the transaction is of a higher than average ticket size, implementing authentication tools to the transaction may fit within the consumer's experience. In some cases, consumers may expect and desire authentication tools be implemented in higher than average ticket size purchases to be reassured that merchants are diligent in their fraud reduction practices. Another example of segmentation metrics describing transactions includes ranges of AA scores that describe different levels of risk or probability that a transaction is fraudulent. If a transaction has a high AA score, it is at a high risk of fraud. A consumer in this case may recognize that this is a high risk transaction and expect authentication tools to be used so that implementing authentication tools in this case fits within consumer's experience.

Authentication segmentation engine 82 groups transactions and/or entities into segments based on shared segmentation metrics. A segment refers to a subset of transactions and/or entities that share a set of segmentation metrics. For example, a segment of merchants 50 may consist of merchants 50 that are in a consolidated industry such as “discount stores” or “electronics & software” stores. In another example, a segment of transactions and merchants 50 may include transactions having a ticket size of over $401 at “discount stores” merchants 50.

Authentication segmentation engine 82 evaluates the transactions and entities based on fraud data 86 to determine which segment(s) they belong to. For example, fraud data may indicate that the average ticket size of transactions conducted at merchant 50 is $5 and the ticket value of a particular transaction is $200. The segmentation metric may be “higher than average ticket size” which indicates using an authentication tool in this case will fit within consumer's experience. In other words, consumer 20 would expect to be authenticated when buying a $200 camera in a convenience store that sells bottled water and gum.

Challenge question engine 84 authenticates transactions by determining challenge questions, issuing the challenge questions, and verifying the answers and other information gathered from the issuance of the challenge questions. Specific details regarding the using and generating challenge questions can be found in U.S. patent application Ser. No. 11/764,343 filed on Jun. 18, 2007 entitled Transaction Authentication Using Network, which is herein incorporated by reference in its entirety for all purposes.

AA engine 82 determines AA scores for transactions and stores the AA scores in AA scores database 87. First, AA engine 82 uses data from a variety of data sources such as fraud data 86 from fraud database 85 and AA scores from AA scores database 87 to develop the predictive model(s) for predicting the likelihood that a transaction is fraudulent. AA engine 82 uses these predictive model(s) to determine AA scores that are used to assess the likelihood that the transactions are fraudulent. Specific details regarding the AA scoring process and the systems for scoring the transactions can be found in U.S. Pat. No. 7,227,950 to Faith et al. entitled Distributed Quantum Encrypted Pattern Generation and Scoring, U.S. Pat. No. 6,119,103 to Basch entitled Financial Risk Prediction Systems and Methods Therefor, U.S. Pat. No. 6,018,723 to Siegel et al. entitled Method and Apparatus for Pattern Generation, and U.S. Pat. No. 6,658,393 to Basch entitled Financial Risk Prediction Systems and Methods therefor. These references are herein incorporated by reference in their entirety for all purposes.

In a typical purchase transaction, consumer 30 purchases a good or service at merchant 50 using portable consumer device 30 such as a credit card. The consumer's portable consumer device 30 can interact with access device 40 such as a POS (point of sale) terminal at merchant 50. For example, consumer 30 may take a credit card and may swipe it through an appropriate slot in the POS terminal. Alternatively, the POS terminal may be a contactless reader, and portable consumer device 30 may be a contactless device such as a contactless card.

An authorization request message is then forwarded to acquirer 60. After receiving the authorization request message, the authorization request message is then sent to payment processing network 70. In some embodiments, AA engine 83 may determine an AA score for the transaction. Payment processing network 70 may then forward the authorization request message to issuer 90 of portable consumer device 30.

After issuer 90 receives the authorization request message, issuer 90 sends an authorization response message back to payment processing network 70 to indicate whether or not the current transaction is authorized (or not authorized). Payment processing network 70 then forwards the authorization response message back to acquirer 60. Acquirer 60 then sends the response message back to merchant 50.

After merchant 50 receives the authorization response message, access device 40 at merchant 50 may then provide the authorization response message for the consumer 30. The response message may be displayed by the POS terminal, or may be printed out on a receipt.

At the end of the day, a normal clearing and settlement process can be conducted by the transaction processing network 70. A clearing process is a process of exchanging financial details between and acquirer and an issuer to facilitate posting to a consumer's account and reconciliation of the consumer's settlement position. Clearing and settlement can occur simultaneously.

Although authentication tools are discussed in many embodiments, other fraud reduction tools may also be available for use by authentication segmentation system 10.

Modifications, additions, or omissions may be made to authentication segmentation system 10 without departing from the scope of the disclosure. For example, payment processing network 70 may include additional or fewer databases and its server 80 may include additional or fewer engines. Moreover, the components of authentication segmentation system 10 may be integrated or separated according to particular needs. Moreover, the operations of authentication segmentation system 10 may be performed by more, fewer, or other system modules. Additionally, operations of authentication segmentation system 10 may be performed using any suitable logic comprising software, hardware, other logic, or any suitable combination of the preceding.

II. Available Authentication Tools

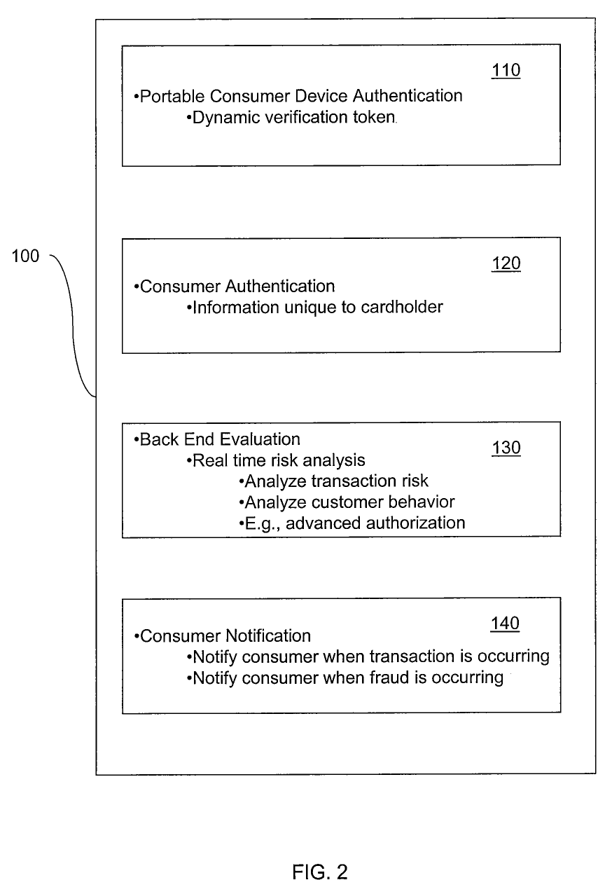

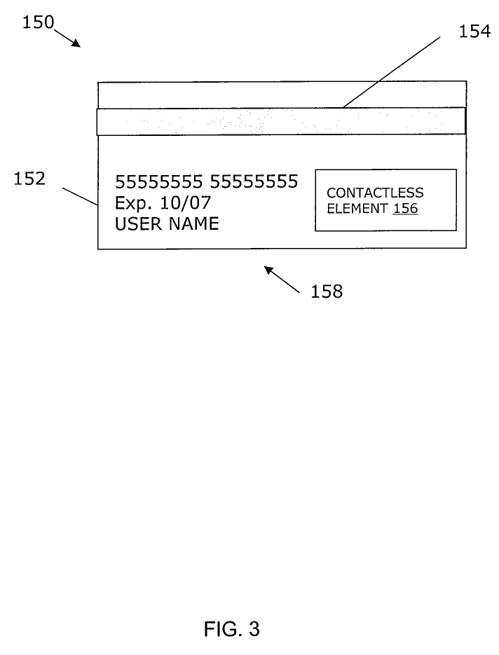

Referring to FIG. 2, which shows a conceptual block diagram 100, the authentication of a purchase transaction like the one described above can have various aspects. Such aspects include portable consumer device authentication 110, consumer authentication 120, back end processing including real time risk analysis 130, and consumer notification of the purchase transaction 140.

Portable consumer device authentication relates to the authentication of portable consumer device 30. That is, in a portable consumer device authentication process, a determination is made as to whether portable consumer device 30 that is being used in the purchase transaction is the authentic portable consumer device or a counterfeit portable consumer device. Specific exemplary authentication tools for improving authentication of portable consumer devices 30 include:
Dynamic card verification value (dCVV) on portable consumer devices such as magnetic stripe cards
Card security features (existing and new)
Contactless chips (limited use)
Magnetic stripe identification
Card Verification Values (CVV and CVV2)
Contact EMV chips

Consumer authentication relates to a determination as to whether or not the person conducting the transaction is in fact the owner or authorized user of portable consumer device 30. Conventional consumer authentication processes are conducted by merchants 50. For example, merchants 50 may ask to see a credit card holder's driver's license, before conducting a business transaction with the credit card holder. Other ways to authenticate consumer 20 can be more effective since consumer authentication at merchant 50 does not occur in every instance. Specific examples of tools that may improve consumer authentication include at least the following:
Knowledge-based challenge-responses such as dynamic challenge responses
Hardware tokens (multiple solution options)
OTPs (one time password, limited use)
AVSs (not as a stand alone solution)
Signatures
Software tokens
PINs (online/offline)
User IDs/Passcodes
Two-channel authentication processes (e.g., via phone)
Biometrics

Back end processing relates to processing that may occur at the issuer or payment processing system, or other non-merchant location. As will be explained in detail below, various processes may be performed at the “back end” of the payment transaction to help ensure that any transactions being conducted are authentic. Back end processing may also prevent transactions that should not be authorized, and can allow transactions that should be authorized.

In addition, specific details of certain authentication tools can be found in the application U.S. patent application Ser. No. 11/764,343 entitled Transaction Authentication Using Network, filed on Jun. 18, 2007. This reference is herein incorporated by reference in its entirety for all purposes.

Lastly, consumer notification is another aspect of transaction authentication. In some cases, a consumer may be notified that a purchase transaction is occurring or has occurred. If the consumer is notified (e.g., via cell phone) that a transaction is occurring using his portable consumer device, and the consumer is in fact not conducting the transaction, then appropriate steps may be taken to prevent the transaction from occurring. Specific examples of consumer notification processes include:
Purchase notification via SMS
Purchase notification via e-mail
Purchase notification by phone

The specific details of the specific aspects may be combined in any suitable manner without departing from the spirit and scope of embodiments of the disclosure. For example, portable consumer device authentication, consumer authentication, back end processing, and consumer transaction notification may all be combined in some embodiments of the disclosure. However, other embodiments of the disclosure may be directed to specific embodiments relating to each individual aspects, or specific combinations these individual aspects.

A. Dynamic Challenge Response (DCR)

A specific example of a consumer authentication tool is a dynamic challenge response method and system. Specific details of dynamic challenge response method and system can be found in U.S. patent application Ser. No. 11/763,240 entitled Consumer Authentication System and Method, filed on Jun. 14, 2007. This reference is herein incorporated by reference in its entirety for all purposes.

In one embodiment, a consumer 20 may use portable consumer device 30 to interact with access device 40 to initiate a purchase transaction. Access device 40 may generate an authorization request message, which may thereafter be sent to a payment processing network 70, and then subsequently to issuer 90 of portable consumer device 30. Challenge question engine 84 determines challenge questions and poses them to consumer 20 to authenticate consumer 20. When the authorization request message is received, it is analyzed by either payment processing network 70 or issuer 90. A challenge question, which can be dynamic or semi-dynamic in nature, is then generated, and is sent to the consumer 20. The challenge question could be sent back to access device 40, or to the consumer's portable consumer device 30 (e.g., if the portable consumer device is a mobile phone).

Consumer 20 then provides an answer to the challenge question. The challenge response answer is received from the consumer 20. The challenge response message is then verified and if it is verified, the authorization response message is analyzed to determine if the transaction is authorized (e.g., there are sufficient funds in the consumers account or there is sufficient credit in the consumer's account). If the transaction is authorized, issuer 90 and also payment processing network 70 send an authorization response message to consumer 20. The authorization response message indicates whether or not the transaction is authorized.

B. Electromagnetic Signature (EM) Card

A specific example of a portable consumer device authentication tool is an EM card. Specific details of an EM card can be found in U.S. patent application Ser. No. 11/764,343 filed on Jun. 18, 2007 entitled Transaction Authentication Using Network, which is herein incorporated by reference in its entirety for all purposes.

In one embodiment, payment processing network 70 or other entity may use portable consumer device fingerprints. For example, two magnetic stripes on two payment cards can store identical consumer data (e.g., account number information), but the magnetic structures of the two magnetic stripes may be different. A specific magnetic structure may be an example of a fingerprint or “DNA” that is associated with a payment card. If a thief copied the consumer data stored on a magnetic stripe to an unauthorized credit card, the magnetic stripe of the unauthorized credit card would have a different magnetic structure or fingerprint than the authorized credit card. A back end server computer receiving the authorization request message in response to the unauthorized card's use would determine that the unauthorized credit card is not real, because the fingerprint is not present in the authorization request message. Two companies that offer this type of technology are Magtek™ and Semtek™. Each company uses its own proprietary algorithm in a point of sale terminal to alter (e.g., encrypt) its own fingerprint before it is sent to an issuer or other entity in a subsequent authentication process.

In embodiments of the disclosure, a portable consumer device fingerprint may include any suitable identification mechanism that allows one to identify the portable consumer device, independent of static consumer data such as an account number or expiration date associated with the portable consumer device. Typically, unlike consumer data, portable consumer device fingerprint data is not known to the consumer. For instance, in some embodiments, the fingerprint data may relate to characteristics of the materials from which the portable consumer devices are made. For example, as noted above, a portable consumer device fingerprint can be embedded within the particular microscopic structure of the magnetic particles in the magnetic stripe in a payment card. In some cases, no two magnetic stripes will have same portable consumer device fingerprint.

C. Dynamic Magnetic Stripe (DM) Card

A specific example of a portable consumer device authentication tool is a dynamic magnetic stripe card having an encrypted dynamic verification value (dCVV). Specific details of a dynamic magnetic stripe card can be found in U.S. patent application Ser. No. 11/940,074 filed on Nov. 14, 2007 This reference is herein incorporated by reference in its entirety for all purposes.

In one embodiment of the dynamic magnetic stripe card, the card or a POS terminal reading the card generates a first dCVV using a counter value that changes after every transaction. The card (or other portable consumer device) or POS terminal (or other access device may send a portion of the counter value and/or first dCVV may be sent embedded in track data to the backend computer operated by a service provider such as payment processing network 70. The backend computer stores the current value of the counter and can calculate a second dCVV using the stored counter value. To verify that the card is authentic, the backend computer matches the second dCVV to the first dCVV received from the front end.

If the first and second verification values do not match, candidate counter values may be calculated using the portion of the counter value. The candidate counter values are then used to determine candidate verification values. If one of the candidate verification values matches the first verification value, the backend computer may determine that the card is authentic. If none of the candidate verification values matches the first verification value, the card may not be authentic and the transaction may be fraudulent. The backend computer may then initiate the sending of an authorization response message to the POS terminal that the transaction is declined.

FIG. 3 is an illustration of components of a magnetic stripe card 150 (e.g., a dynamic magnetic stripe card), in accordance with an embodiment of the invention. FIG. 3 shows a plastic substrate 152. A contactless element 156 for interfacing with an access device such as a point of sale terminal may be present on or embedded within the plastic substrate 152. Consumer information 158 such as an account number, expiration date, and consumer name may be printed or embossed on the card. A magnetic stripe 154 may also be on the plastic substrate 152. The illustrated example of magnetic stripe card 150 includes both a magnetic stripe 154 and a contactless element 156. In other examples, both magnetic stripe 154 and the contactless element 156 may be in the card 150. In yet other examples, either the magnetic stripe 154 or the contactless element 156 may be present in the card 150.

III. Method of Segmented Authentication

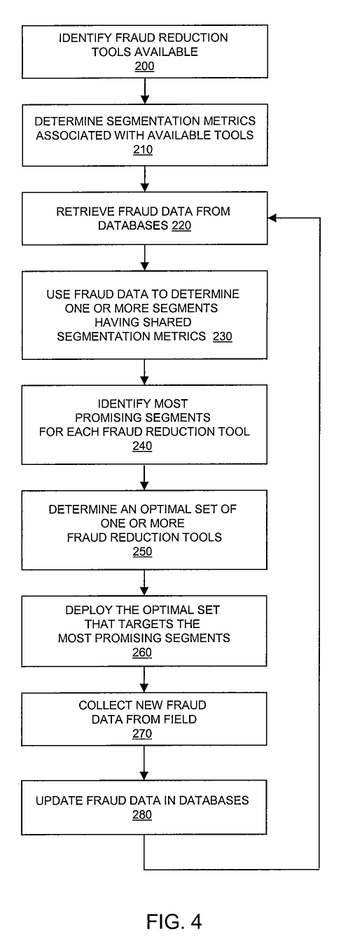

FIG. 4 is a flowchart illustrating a method of segmented authentication, in accordance with an embodiment of the disclosure. The method begins by authentication segmentation engine 82 identifying the fraud reduction tools (e.g., authentication tools) available for use by authentication segmentation system 10 (step 200). The fraud reduction tools may be available for use at the time that the method is used or may be made available for use at a later time. In some cases, the available fraud reduction tools may already be deployed. In other cases, the available fraud reduction tools may not be deployed. Any party associated with authentication segmentation system 10 or outside of authentication segmentation system 10 may provide fraud reduction tools for use by authentication segmentation system 10.

Each fraud reduction tool is associated with a plurality of segmentation metrics. For example, two segmentation metrics associated with DCR authentication are “high AA scores” and “higher than average ticket size.” Transactions having one or both these two segmentation metrics are transactions that are at a high risk of being fraudulent. DCR authentication would be an effective tool for reducing fraud for these high risk transactions having high AA scores and/or higher than average ticket size.

Authentication segmentation engine 82 determines the segmentation metrics associated with each available fraud reduction tool (step 210). Segmentation metrics may not be unique to each fraud reduction tool. A fraud reduction tool may be associated with the same or similar segmentation metric as another fraud reduction tool. In one case, authentication segmentation engine 82 may retrieve segmentation metrics from the entity that provided the fraud reduction tool. In another case, authentication segmentation engine 82 may retrieve the segmentation metrics from one or more of the databases 86, 87, and 88.

In some cases, authentication segmentation engine 82 may develop segmentation metrics associated with a fraud reduction tool. In these cases, authentication segmentation engine 82 may analyze historical fraud data resulting from the fraud reduction tool being deployed in the field. Authentication segmentation engine 82 determines which transactions and entities benefited the most from the fraud reduction tool and determines the characteristics shared by those transactions and entities. Authentication segmentation engine 82 develops segmentation metrics based on these shared characteristics derived from the historical fraud data. For example, authentication segmentation engine 82 may analyze historical fraud data and determine that deploying DCR authentication has reduced the total fraud dollars by 50% on transactions having an AA score of 30-39. Based on this historical fraud data, authentication segmentation engine 82 may determine that a segmentation metric associate with DCR authentication is “AA score of 30-39.”

Authentication segmentation engine 82 retrieves fraud data 86 from one or more databases associated with a set of transactions and entities (step 220). In some cases, the fraud data retrieved is all fraud data available to authentication segmentation system 10. The set of transactions and entities in these cases includes all transactions and entities associated with available fraud data. In other cases, issuer 90 may select certain transactions and entities to be used. In these cases, the fraud data associated with theses transactions and entities is retrieved. Authentication segmentation engine 82 may retrieve fraud data 86 from one or more database inside and outside of authentication segmentation system 10. In one case, authentication segmentation engine 82 retrieves fraud data 86 from fraud database 85. In another case, authentication segmentation engine 82 retrieves fraud data other databases. For example, authentication segmentation engine 82 may retrieve AA scores associated with transactions from AA scores database 87. In another example, authentication segmentation engine 82 may retrieve data from a third party vendor that supplied a fraud reduction tool.

Authentication segmentation engine 82 uses fraud data to determine one or more segments having shared segmentation metrics (step 230). Authentication segmentation engine 82 uses the fraud data to determine the characteristics of the transactions and entities and determine whether particular transactions and entities are associated with fraudulent activities. Authentication segmentation engine 82 groups those transactions and entities having the characteristics defined by the segmentation metrics associated with available fraud reduction tools.

Authentication segmentation engine 82 identifies the most promising segment(s) for each available fraud reduction tool using fraud data (step 240). The most promising segment(s) are the best candidates for deployment of the fraud reduction tool. In some cases, authentication segmentation engine 82 may identify segments that have the highest risk transactions and/or the highest risk entities. In other cases, authentication segmentation engine 82 may identify one or more segments that involve the highest percentage of total fraud dollars and/or the lowest number of transactions.

For example, an available fraud reduction tool may be DCR authentication which has a segmentation metric of “higher than average ticket size.” Fraud data 86 may be retrieved for 1000 transactions at a group of convenience stores. Fraud data 86 may indicate that the average ticket size at the convenience stores is $5. The fraud data may also show that of the 1000 transactions, 5 transactions have a ticket value over $500 and 995 transactions have a ticket value under $3. Authentication segmentation engine 82 groups the 5 transactions having a ticket size over $500 into a high risk segment having “higher than average ticket size” and the other 995 transactions into a low risk segment. The high risk segment would be identified as the most promising segment for DCR authentication. Deploying DCR authentication on the high risk segment will mostly likely fit within consumer's experience since consumer 20 would expect to be authenticated when making a $500 purchase at a convenience store.

Authentication segmentation engine 82 determines an optimal set of one or more fraud reduction tools based on optimization factors (step 250). Authentication segmentation engine 82 also selects the most promising segments to target by the optimal set based on optimization factors. Optimization factors refer to any suitable criteria associated with maximizing efficiency and effectiveness of the fraud //reduction tools. Any suitable optimization factor can be used. Some examples of optimization factors include maximizing ROI for deploying fraud reduction tools and minimizing consumer inconvenience. Maximizing ROI can include factors such as minimizing cost of deploying the tools and/or maximizing the reduction of total fraud dollars. Minimizing customer inconvenience can include factors such as minimizing the number of consumers 20 effected by the fraud reduction tools, minimizing time spent in conducting the transaction, minimizing difficulty in conducting the transaction, and minimizing erroneous triggering of fraud alarms. Optimization factors may be defined by the authentication segmentation engine 82 or other suitable entity.

In one embodiment, authentication segmentation engine 82 determines the extent to which each of the fraud reduction tools contributes to the optimization factors. Authentication segmentation engine 82 determines combinations of fraud reduction tools and their associated most promising segments. For example, if there are three available fraud reduction tools, there could potentially be 3! combinations. Authentication segmentation engine 82 may reduce the total number of combinations by eliminating those unfeasible combinations. Authentication segmentation engine 82 analyzes the combinations to determine the optimal combination of one or more fraud reduction tools that contributes to the optimization factors. In some cases, authentication segmentation engine 82 may weight certain optimization factors more heavily than others. For example, authentication segmentation engine 82 may determine that there are three fraud reduction tools A, B, and C. According to fraud data, A has been shown to reduce total fraud dollars by 10%, B has been shown to reduce total fraud dollars by 20%, and C has been shown to reduce total fraud dollars by 30%. If A is deployed on its high risk segment a, it will effect 2 consumers per day. If B is deployed on its high risk segment b, it will effect 5 consumers per day. If C is deployed on its high risk segment c, it will effect 100 consumers per day. If consumer inconvenience is weighted much higher than reduction of fraud, A and B may be selected since only 7 consumers will be effected each day and potentially 30% of the total fraud dollars will be reduced. If return on investment is weighted more heavily than consumer inconvenience, C may be selected since it will reduce fraud by 30% and the cost of only one fraud reduction tool will be incurred.

The optimal set of one or more fraud reduction tools is deployed to target the selected most promising segments (step 260). Other transactions and/or entities outside of the targeted segments are not subjected to the fraud reduction tools. In one embodiment, the method ends when the optimal set of one or more fraud reduction tools is deployed.

Once the optimal set of tools are in place, new fraud data may be generated reflecting new fraudulent activities. This new fraud data is stored in the databases. The new fraud data is collected from the field after the fraud reduction tools are deployed (step 270). The fraud data 86 may be collected by any suitable entity (e.g., payment processing network 70 or issuer 90) inside authentication segmentation system 10 and/or any suitable entity outside of authentication segmentation system 10.

The new fraud data is used to update fraud data 86 in one or more databases (step 280). Once the fraud data is updated, authentication segmentation engine 82 may use the updated fraud data to identify a new set of most promising segments for the same or different set of fraud reduction tools. In one case, authentication segmentation engine 82 identifies a new set of fraud reduction tools that is not currently deployed in the field and determines which of the tools target remaining high risk segments. In this way, authentication segmentation engine 82 can fill in any gaps left open by the already deployed fraud reduction tools. In another case, authentication segmentation engine 82 can identify other segments that should be targeted by the currently deployed fraud reduction tools.

For example, authentication segmentation engine 82 can deploy DCR authentication to target a particular segment at high risk for fraud having an AA score greater than 40. During deployment, challenge question engine 84 generates challenge questions from challenge question database 88 to authenticate transactions having AA scores greater than 40. While DCR authentication is in place, those transactions that had an AA score greater than 40 before deployment are now at a lower risk for fraud. AA engine 83 generates new, lower values for the AA scores for those transactions. AA scores and other fraud data associated with those transactions is updated in the various databases such as AA scores database 87 and fraud database 85. Authentication segmentation engine 82 retrieves the new, updated AA scores. Authentication segmentation engine 82 uses the updated AA scores to identify a new set of most promising segments and a new optimal set fraud reduction tools that optimally target one or more of the segments in the new set of most promising segments.

Modifications, additions, or omissions may be made to the method without departing from the scope of the disclosure. The method may include more, fewer, or other steps. Additionally, steps may be performed in any suitable order without departing from the scope of the disclosure.

III. An Example of Segmentation for DCR Authentication

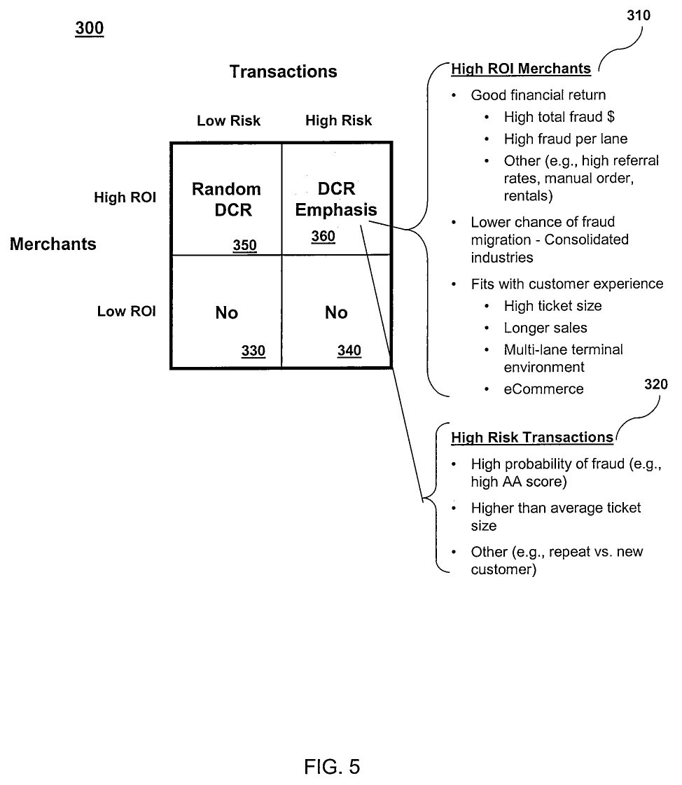

FIG. 5 is a table 300 schematically illustrating segmentation for DCR authentication, in accordance with an embodiment of the disclosure. In this example, merchants 50 and transactions conducted at those merchants 50 are segmented using segmentation metrics associated with DCR authentication. These segmentation metrics include segmentation metrics related to high ROI merchants 310 and segmentation metrics related to high risk transactions 320.

Segmentation metrics associated with high ROI merchants 310 that indicate a potential for good financial return include: high total fraud dollars, high fraud per lane, and other good financial return metrics (e.g., high referral rates, manual order, rentals). Segmentation metrics associated with high ROI merchants 310 that potentially indicate a lower chance of fraud migration include: consolidated industries. Segmentation metrics associated with high ROI merchants 310 that indicate fitting with consumer experience include: high ticket size, longer sales, multilane terminal environment, and eCommerce. Segmentation metrics associated with high risk transactions 320 include a high probability of fraud (e.g., a high AA score), a higher than average ticket size, and other high risk metrics (e.g., repeat vs. new customer).

Fraud data for the transactions and merchants is compared to the segmentation metrics defined for DCR authentication. This comparison is used to categorize the transactions and associated merchants into one of the segments of Low ROI-Low Risk segment 330, Low ROI-High Risk segment 340, High ROI-Low Risk segment 350, and High ROI-High Risk segment 360.

In this example, two segments of High ROI-Low Risk segment 350 and High ROI-High Risk segment 360 are selected as the most promising segments to benefit from DCR authentication. DCR authentication will be deployed on a random basis to transactions in the High ROI-Low Risk segment 350. DCR authentication will be deployed to all transactions in the High ROI-High Risk segment 360.

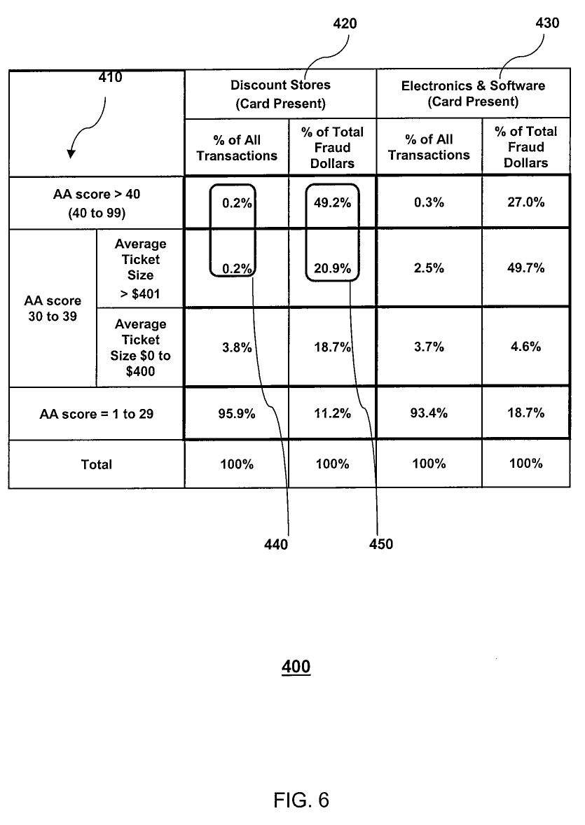

FIG. 6 is a table 400 of results from segmentation of transactions based on DCR authentication, in accordance with an embodiment of the disclosure. In table 400, transactions are categorized by segmentation metrics including AA score ranges 410 and type of industry including discount stores 420 and electronic and software 430. The AA score ranges include AA score >40 (40 to 99) (high risk), AA score of 30 to 39 (medium risk), and AA score of 1 to 29 (low risk). The AA score range of 30 to 39 is further divided into average ticket size greater than $401 and average ticket size of $0-$400.

This example of DCR segmentation resulted in eight segments. A first segment includes transactions having an AA score greater than 40 for purchases at discount stores. A second segment includes transactions having an AA score of 30 to 39 and an average ticket size of greater than $401 for purchases at discount stores. The third segment includes transactions having an AA score of 30 to 39 and an average ticket size 0$ to $400 for purchases at discount stores. The fourth segment includes transactions having an AA score from 1 to 29 for purchases at discount stores. The fifth segment includes transactions having an AA score greater than 40 for purchases at electronics and software stores. A sixth segment includes transactions having an AA score of 30 to 39 and an average ticket size of greater than $401 for purchases at electronics and software stores. The seventh segment includes transactions having an AA score of 30 to 39 and an average ticket size 0$ to $400 for purchases at electronics and software stores. The eighth segment includes transactions having an AA score from 1 to 29 for purchases at electronics and software stores.

The percentage of total fraud dollars associated with the transactions in each segment is shown. The percentage of all transactions associated with the transactions in each segment is also shown. For example, the first segment includes 0.2% of all transactions and 49.2% of total fraud dollars. As another example, the second segment includes 0.2% of all transactions and 20.9% of total fraud dollars. Combined, the first and second segments are associated with 0.4% of all transactions 440 and are associated with 72.1% of total fraud dollars 450.

Table 400 indicates that a targeted deployment of DCR authentication on first and second segments will cause only 0.4% of all transactions to be authenticated with a potential of reducing 72.1% of total fraud dollars. Based on this analysis, authentication segmentation engine 82 selects first and second segments as the most promising segments having the greatest potential for maximizing ROI and for minimizing consumer inconvenience. ROI would be maximized because the cost of deploying DCR authentication is minimal since it is only deployed to a small percentage of transactions (0.4%) and the potential for reducing fraud dollars is high at 72.1%. Consumer inconvenience is minimized since very few consumers 20 will have their transactions authenticated with challenge questions since only 0.4% of the transactions are targeted.

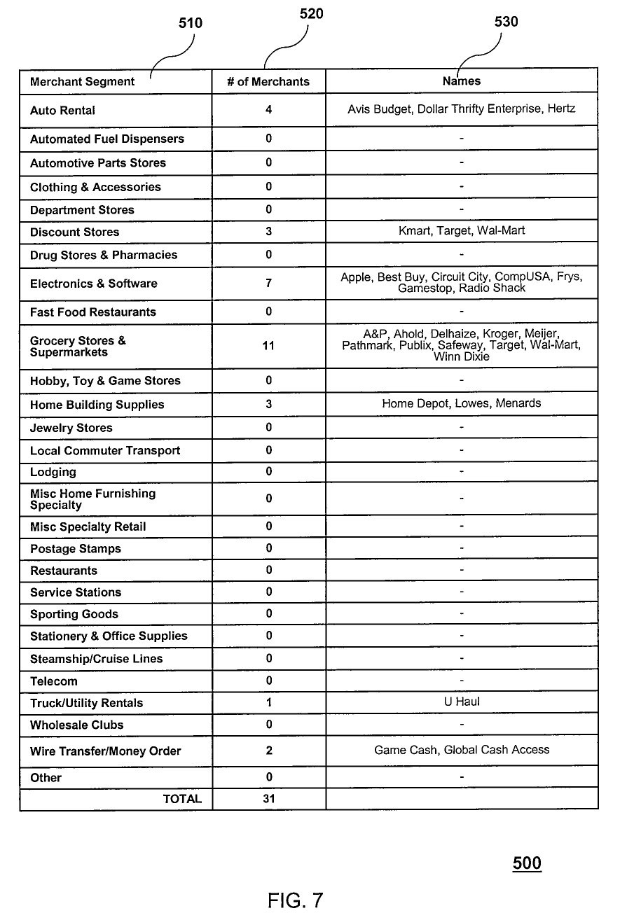

FIG. 7 is a table 500 of results from segmentation of merchants 50 based on DCR authentication, in accordance with an embodiment of the disclosure. In the table 500, merchants are categorized by segmentation metrics of type of merchant 510. Some examples of types of merchants 510 include auto rental, automated fuel dispensers, automotive parts stores, clothing and accessories, department stores, discount stores, drug stores and pharmacies, electronics and software, fast food restaurants, and grocery stores and supermarkets.

In this example, segmenting merchants 50 by type of merchant 510 resulted in 28 segments. Table 500 shows the number of merchants 520 in each segment and the names 530 of the merchants in each segment. Table 500 indicates the consolidated industries of merchants 50. In some cases, authentication segmentation engine 82 could target consolidated industries to target with DCR authentication in order to avoid fraud migration to other merchants 50 in the same consolidated industry.

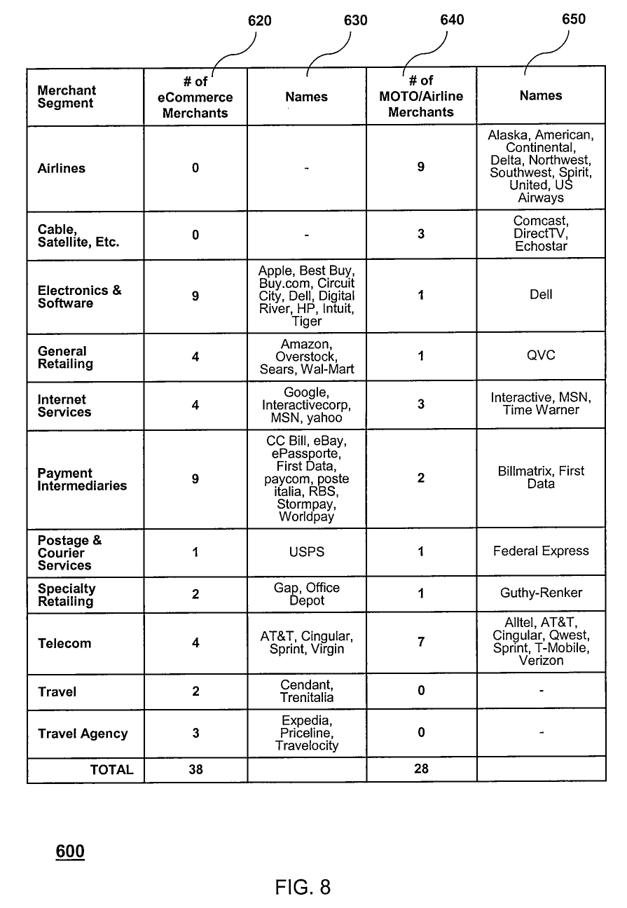

FIG. 8 is a table 600 of results from segmentation of merchants 50 based on DCR authentication, in accordance with an embodiment of the disclosure. In the table 600, merchants are categorized by segmentation metrics of type of merchant and the type of transaction conducted by the merchants such as eCommerce 620 or MOTO/Airline 640. Some examples of types of merchants include airlines, cable, satellite, etc., electronics and software, general retailing, internet services, payment intermediaries, postage and courier services, specialty retailing, telecom, travel, and travel agency.

In this example, segmenting merchants 50 by type of merchant and type of transaction resulted in 22 segments. Table 600 shows the number of merchants 620 and 640 in each segment and the names 630 and 650 of the merchants in each segment.

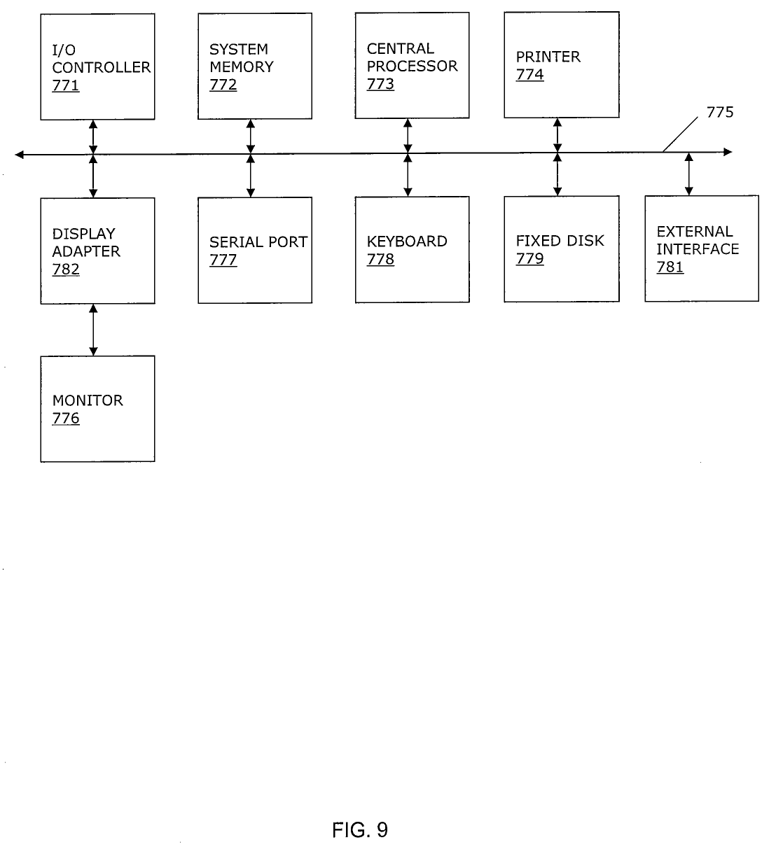

The various components and elements in the previously described Figures (e.g., FIGS. 1-8) may operate using one or more computer apparatuses to facilitate the functions described herein. Any of the elements in the Figures may use any suitable number of subsystems to facilitate the functions described herein. Examples of such subsystems or components are shown in FIG. 9. The subsystems shown in FIG. 9 are interconnected via a system bus 775. Additional subsystems such as a printer 774, keyboard 778, fixed disk 779 (or other memory comprising computer readable media), monitor 776, which is coupled to display adapter 782, and others are shown. Peripherals and input/output (I/O) devices, which couple to I/O controller 771, can be connected to the computer system by any number of means known in the art, such as serial port 777. For example, serial port 777 or external interface 781 can be used to connect the computer apparatus to a wide area network such as the Internet, a mouse input device, or a scanner. The interconnection via system bus allows the central processor 773 to communicate with each subsystem and to control the execution of instructions from system memory 772 or the fixed disk 779, as well as the exchange of information between subsystems. The system memory 772 and/or the fixed disk 779 may embody a computer readable medium. Any of these elements may be present in the previously described features. For example, the previously described directory server and access control server may have one or more of these components shown in FIG. 9.

Any of the components, elements, or functions described above can be implemented in the form of control logic using software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network. Based on the disclosure and teachings provided herein, a person of ordinary skill in the art will know and appreciate other ways and/or methods to implement the present disclosure using hardware and a combination of hardware and software.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed. Moreover, any one or more features of any embodiment of the invention may be combined with any one or more other features of any other embodiment of the invention, without departing from the scope of the invention.

A recitation of “a”, “an” or “the” is intended to mean “one or more” unless specifically indicated to the contrary.

All patents and patent applications mentioned above are herein incorporated by reference in their entirety for all purposes. None is admitted to be prior art.

1. A method comprising:
identifying a plurality of fraud reduction tools;
determining segmentation metrics associated with the plurality of fraud reduction tools;
determining one or more segments based on the segmentation metrics using fraud data;
identifying the best candidates of the one or more segments; and
selecting one or more fraud reduction tools of the plurality of available fraud reduction tools, wherein the one or more fraud reduction tools target the best candidates.

2. The method of claim 1, further comprising deploying the one or more fraud reduction tools to target the best candidates.

3. The method of claim 2, further comprising:
collecting new fraud data resulting from the deployment of the one or more fraud reduction tools; and
determining one or more new segments based on the plurality of metrics using the new fraud data.

4. The method of claim 3, further comprising:
identifying a new best candidate; and
selecting a new fraud reduction tool of the plurality of available fraud reduction tools, wherein the new fraud reduction tools targets the new best candidate.

5. The method of claim 1, further comprising retrieving the fraud data from one or more databases.

6. The method of claim 5, further comprising:
deploying the one or more fraud reduction tools to target the best candidates.
collecting new fraud data resulting from the deployment of the one or more fraud reduction tools; and
storing the new fraud data in the one or more databases.

7. The method of claim 1, wherein the one or more segments comprise transactions and merchants associated with the transactions.

8. The method of claim 1, wherein the fraud data is associated with transactions made using a plurality of portable consumer devices.

9. The method of claim 1, wherein selecting one or more fraud reduction tools of the plurality of available fraud reduction tools, wherein the one or more fraud reduction tools target the best candidates, comprises determining an optimal set of the plurality of available fraud reduction tools using optimization factors.

10. The method of claim 9, wherein the optimization factors include return on investment.

11. The method of claim 9, wherein the optimization factors include customer inconvenience.

12. The method of claim 1, wherein the plurality of available fraud reduction tools includes a plurality of authentication methods.

13. The method of claim 12, wherein the plurality of authentication methods include a dynamic magnetic stripe card method, an electromagnetic signature card method, and a dynamic challenge response method.

14. A computer readable medium, comprising:
code for identifying a plurality of fraud reduction tools;
code for determining segmentation metrics associated with the plurality of fraud reduction tools;
code for determining one or more segments based on the segmentation metrics using fraud data;
code for identifying the best candidates of the one or more segments; and
code for selecting one or more fraud reduction tools of the plurality of available fraud reduction tools, wherein the one or more fraud reduction tools target the best candidates.

15. The computer readable medium of claim 14, further comprising code for deploying the one or more fraud reduction tools to target the best candidates.

16. The computer readable medium of claim 15, further comprising:
code for collecting new fraud data resulting from the deployment of the one or more fraud reduction tools; and
code for determining one or more new segments based on the plurality of metrics using the new fraud data.

17. The computer readable medium of claim 16, further comprising:
code for identifying a new best candidate; and
code for selecting a new fraud reduction tool of the plurality of available fraud reduction tools, wherein the new fraud reduction tools targets the new best candidate.

18. The computer readable medium of claim 14, wherein the code for selecting one or more fraud reduction tools of the plurality of available fraud reduction tools includes code for determining an optimal set of the plurality of available fraud reduction tools using optimization factors.

19. A system comprising:
one or more databases for storing fraud data; and
a server coupled to the one or more databases, the server configured to:
identify a plurality of fraud reduction tools;
determine segmentation metrics associated with the plurality of fraud reduction tools;
retrieve fraud data from the one or more databases;
determine one or more segments based on the segmentation metrics using the fraud data;
identify the best candidates of the one or more segments; and
select one or more fraud reduction tools of the plurality of available fraud reduction tools, wherein the one or more fraud reduction tools target the best candidates.
